(19) United States
(12) Patent Application Publication
(10) Pub. No.: US 2008/0135352 A1
(43) Pub. Date: Jun. 12, 2008

(54) Brake caliper vertical mounting assembly joint arrangement

(75) Inventor: Steven C. Bell, Amherst, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Spicer Foundation Brake LLC, Elyria, OH (US)

(21) Appl. No.: 11/636,978

(22) Filed: Dec. 12, 2006

(51) Int. Cl. F16D 65/18; F16D 55/224

(52) U.S. Cl. 188/73.39; 188/72.1

(57) ABSTRACT

A pneumatically- or electrically-actuated disk brake, in which a mounting frame supports a brake caliper and a torque plate secures the mounting plate to an axle, are arranged such that fasteners securing the mounting frame to the torque plate are oriented essentially perpendicular to the axle's longitudinal axis. Between the mounting frame and the torque plate are arranged locating features and corresponding recesses which constrain relative motion between the frame and the plate in at least two degrees of freedom. The locator features may include a shear sleeve or locator pin capable of constraining two degrees of motion, and parallel and perpendicular ridges arranged to constrain motion in at least three directions. The locator features aid in avoiding stress concentrations and distortions in the brake mount and caliper during brake application, and improve brake pad wear by better maintaining an optimum geometry of the pads relative to the brake rotor.

### BACKGROUND AND SUMMARY OF THE INVENTION

The present invention relates to disk brakes, and in particular to a mounting system for a brake caliper mounting frame assembly of a disk brake.

Pneumatically-operated disc brakes have been undergoing development and deployment, particularly on commercial vehicles, since at least the 1970's. These disk brakes are beginning to replace drum-style brakes due to advantages in areas such as cooling, fade resistance and serviceability. German patent publication DE 40 32 886 A1, and in particular FIG. 1 of this document, discloses an example of such an air disc brake.

The adaptation of disc brake technology to commercial vehicle applications has not been without engineering challenges. Commercial vehicle wheel rims are sized, both in diameter and axial offset, to provide adequate clearance for the drum-type brakes historically employed on such vehicles. The resulting space envelope between the wheel and its axle is limited, leaving little space available for a pneumatic disc brake. This lack of available space in turn results in the need to design the brake components, such as mounting flanges (for example, “torque plates” which are bolted to an axle housing, or flanges permanently fixed to the axle housing), to conform to the constrained space envelope and avoid interference with nearby vehicle components, such as an immediately adjacent axle flange.

Previous pneumatic disk brake designs typically use a brake caliper which straddles a friction portion of brake disk located on an axle hub. The brake caliper in such brakes is mounted to an intermediate mounting frame (also known as a “carrier”), which in turn is affixed to a mounting plate (known as a “torque plate”) which transfers the braking torque generated by the caliper to the vehicle axle. An example of such prior art brake arrangements is shown in FIG. 1, which is a detailed partial view showing the arrangement of a caliper 1 located at either caliper end by pins 2 (second pin not shown) on mounting frame 3. The caliper mounting frame 3 is held to torque plate 4 by bolts (not illustrated) which pass through torque plate holes 5 and thread into corresponding threaded holes in the mounting frame 3. The torque plate may be affixed to the axle in various ways, such as welding to the axle housing, however, the most common approach is bolting of the torque plate through holes 6 to an axle flange which is perpendicular to the axle longitudinal axis (flange not illustrated for clarity).

There are several disadvantages to the previous caliper mounting frame arrangements, many of which stem from the configuration of the frame mounting bolts, which are generally parallel to longitudinal axis of the axle. The previous designs require installation tool clearance behind the torque plate to permit insertion and/or removal of the frame mounting bolts and insertion of an installation tool to tighten and/or loosen the bolts. Achieving sufficient clearance for frame mounting bolt installation and/or removal is problematic due to the close proximity of other vehicle components, such as the axle housing, axle flanges, vehicle suspension (e.g., leaf springs and brackets, shock absorbers and mounts), and steering components (e.g., tie rod ends, and arms, steering arm). These space constraining components frequently require the disk brake caliper and its mounting frame to be “clocked” (rotated about the longitudinal axis of the axle) away from an optimum brake performance position, in order to avoid interference with other vehicle components during brake operation or service. Even with clocking of the brake to a sub-optimum position about the axle, access to at least one of the mounting frame bolts usually remains limited, preventing the use of time- and labor-saving power tools (e.g., a pneumatic wrench) during bolt installation and removal.

Further disadvantages of the previous mounting bolt arrangements result from the need to include excess additional material to certain portions of the caliper mounting frame and torque plate, which can lead to compromising the strength of these components in order to fit the disk brake into the available space envelope. For example, because the frame mounting bolts are parallel to the longitudinal axis of the axle, and must be threaded into the mounting frame (in order to minimize bolt projection from the torque plate toward the longitudinal center of the axle), a significant amount of extra frame material must be provided around the mounting bolt holes to support the bolt threads. Given its location at the extreme ends of the caliper mounting frame, this extra frame material does not improve the structural strength of the mounting frame, and thus only adds to the weight of the frame. Further, in order to provide sufficient material about the mounting bolt holes to ensure sufficient bolt thread engagement in the mounting frame, the mounting frame ends typically are so thick that the portion of the torque plate containing the mounting frame mounting bolt holes must be offset away from the brake disk so that there is enough room between the disk and the torque plate to accommodate the enlarged mounting frame ends. As a result of the offset, thin-walled sections are created in the torque plate in the transition regions between the offset mounting bolt holes and the center portion of the plate that is bolted to the axle flange. These thin-walled sections are highly stressed, and past practice has been to added additional material in adjoining areas of the torque plate to reduce the stress concentration in the thin-walled sections. This additional material, resulting from the longitudinal mounting frame mounting bolt orientation, is an additional inefficient use of structural material, further increasing brake weight and cost.

Many of the problems of the prior art caliper mounting designs are addressed by the new disk brake caliper mounting arrangement set forth in of U.S. patent application Ser. No. 11/110,774, the disclosure of which is incorporated herein by reference in its entirety. This Application is directed to an improved disk brake mounting arrangement, as shown for example in FIG. 2 (FIG. 4 of the Ser. No. 11/110,774 application), which is lighter, simpler, less costly and/or easier to assemble and service, in which a brake caliper mounting frame 20 (holding a caliper 12) and a corresponding torque plate 30 are arranged such that the mounting bolts 32 are oriented in one or more planes which are generally perpendicular to the longitudinal axis 33 of the vehicle axle. The mounting bolts 32 may be oriented radially away from the longitudinal axis of the axle, or, as shown in FIG. 2, may be oriented in a generally tangential direction, and may be inserted radially inward through the top of the mounting frame into threads in the torque plate, or, as shown in FIG. 2, radially outward through holes in the torque plate flange into threads in the mounting frame. An alternative arrangement of the mounting bolts and the corresponding mounting frame and torque plate carrier mating surfaces is shown in FIG. 3 (FIG. 7 of the Ser. No. 11/110,774 application). In this embodiment, the frame/plate mating surfaces are not parallel to one another, but the mounting bolts remain arranged generally perpendicular to the longitudinal axis of the axle, as in the FIG. 2 embodiment. Among the advantages of the new approach of the Ser. No. 11/110,774 application, is the elimination of: the need for excess material to be provided at the ends of the intermediate mounting frame; the need to provide an offset in the mounting hole portion of the torque plate; the need to “clock” the brake assembly away from an optimal angular position about the longitudinal axis of the axle; and access issues which limit the serviceability of the brake.

While the vertical caliper mounting arrangements of the Ser. No. 11/110,774 approach offers numerous advantages over prior art longitudinally-oriented mounting bolt designs, new brake designs utilizing the concepts of the Ser. No. 11/110,774 application require careful design of the caliper mounting bracket, torque plate, and the joints between these components to ensure design limits for allowable stresses, fatigue life, etc., will be met. Prior art mounting bracket-to-axle mounts (e.g., torque plates) typically had pairs of parallel machined mating surfaces perpendicular to the longitudinal axis of the axle, with one or more fastener clamping the components together. Due to their orientation, a primary loading direction when the brake is applied is in shear along the components' mating surfaces. These joints rely on friction between the faces (a function of the clamping load of the fasteners) to maintain the orientation of the parts relative to one another, and thereby avoid flexing or other displacements which can lead to distortion of the caliper, binding of the caliper on its sliding pins and highly-localized stress in brake components.

The arrangements taught by the Ser. No. 11/110,774 application place the mounting frame/torque plate mating surfaces perpendicular to the prior art location of these surfaces. These surfaces and their mounting bolts therefore are loaded in an entirely different manner when the brake is applied than with a prior art mounting arrangement. Nonetheless, it remains important to maintain a postionally-fixed relationship between the caliper bracket and its mount to prevent flexing or shifting of the brake components relative to one another, which can lead to very high stresses in localized areas of the brake, including in the portion of the mounting bracket straddling the brake disk rotor. These high stresses raise concerns with not only immediate component failure, but also a greatly decreased fatigue life and potential fatigue failure well short of the typical 50,000 cycle life of a commerical vehicle brake.

One approach to preventing relative motion (e.g., slippage) between the brake mounting components is to apply greater clamping loads between the mounting frame and the torque plate to increase the friction force between these two components. This can be accomplished by increasing the size of the mounting bolts, which in turn requires increasing the size of the mounting frame and torque plate to accommodate the larger bolts. However, this approach may be viable in applications such as Euorpean commerical vehicles which have considerably larger wheel rims, it is not practical in more demanding vehicle applications, such as U.S. commerical vehicles which typically operate with smaller wheels with extremely limited space between the brake and the inner wheel rim surface.

The present invention addresses the problems of brake component relative motion arising from the re-location of mounting and fastening surfaces in the vertical mounting system by use of locator features between the caliper mounting frame and the corresponding torque plate mating surfaces to minimize bolted joint tolerances and to resist rotating and/or sliding movements, thereby minimizing slippage-induced distortion of the caliper and maintaining a precise alignment of the caliper mounting frame relative to the brake disk rotor.

One embodiment of a locator feature to prevent relative motion between the mounting frame and the torque plate is a shear sleeve engaging both frame and plate mating surfaces. This so-called “4-way locator” limits two degrees of freedom, preventing slippage in both the transverse and axial directions relative to the axle.

This locator feature may be combined in other embodiments with other locator features, such as a “clocking” feature which limits a third degree of freedom (i.e., rotation about an axis perpendicular to the axle). Such a clocking feature may include, for example, a ridge on the opposite torque plate mating surface. The ridge could be located at the edge of either the torque plate or the mounting frame mating surface, thereby requiring only simple machining of a corresponding receiving groove on a side surface of the receiving plate or frame component. Alternatively, the ridge may be located more toward the center of the mating surface, and a corresponding groove provided in the face of the opposite mating surface.

It will be readily understood by one of ordinary skill that the clocking feature is not limited to a ridge, but could be any suitable engagement feature, such as a pin or dowel inserted into corresponding holes or slots in the opposing mating surfaces or in an abutting engagment similar to the ridge described above. Moreover, several locating features may be provided on one mating surfaces, including ridges, pins and other such elements. Further, a second shear sleeve (or alternatively, a pin or dowel, etc.) may also be used with the first locating feature, for example, in the opposing mating surface. However, in all these alternative embodiments of the present invention, care must be taken to avoid over-constraint of the degrees of freedom of the joint, lest the mating halves become prone to binding during brake assembly and servicing.

In another embodiment, a ridge, such as a shoulder located at an inboard or outboard edge of the frame or plate mating surfaces, may be provided on both mating surfaces, preferably in parallel with one another. This arrangement would provide resistance against movement either inboard or outboard in the axial direction relative to the axle, as well as provide resitance to rotating (“clocking”) about an axis perpendicular to the axle. A third ridge could be provided on one of the adjacent perpedicular mating surfaces to prevent movement in the transverse direction. The combination of these three ridges would thus desirably contrain three degrees of freedom in a simple and cost-effective manner.

Additional embodiments may include other motion-resisting locator features which engage corresponding receiving holes in the flange and/or plate mating surfaces, such as pins, separate ridges (rather than ridges formed from the component base material) or other insertable objects which present lateral surfaces to both the mounting frame and torque plate, shoulder bolts with close tolerance fit into corresponding counter-bores, etc.

One advantage of the present invention is that the locator features may be designed to provide the desired resistance to movement, yet need not over-constrain the joint, such that there is unnecessary binding which might cause difficulty in assembly or service operations. Other advantages include improved brake pad wear as a result of the more precise and accurate alignment of the brake caliper relative to the brake disk rotor, and the ability to “error proof” assembly processes by arranging the locator features on the mounting frame and/or torque plate in a manner which precludes improper assembly of a left-side brake component in a right-side installation, and vice-versa.

Other objects, advantages and novel features of the present invention will become apparent from the following detailed description of the invention when considered in conjunction with the accompanying drawings.

### BRIEF DESCRIPTION OF THE DRAWINGS

FIG. 1 is a oblique partial view of a prior art pneumatic disk brake caliper and mounting assembly.

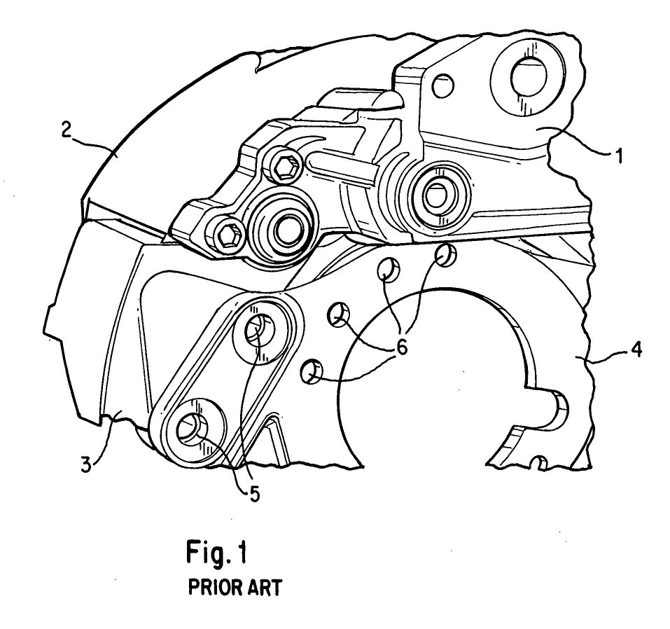

FIG. 2 is an exploded elevation view of an embodiment of a pneumatic disk brake mounting system with vertically-oriented mounting bolts and mating surfaces.

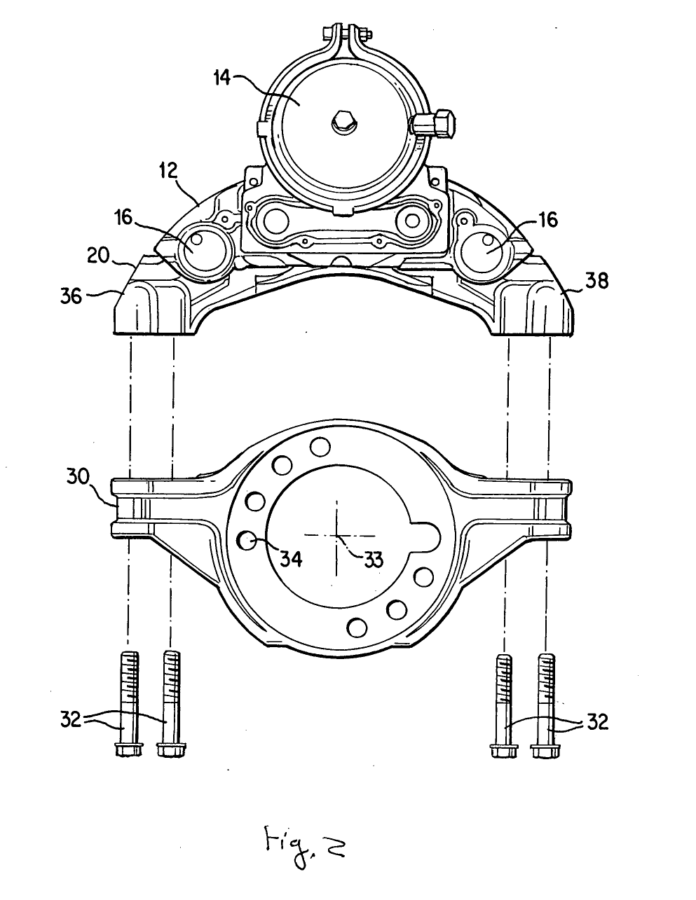

FIG. 3 is an exploded elevation view of mounting frame and torque plate arrangements of an embodiment of a pneumatic disk brake having non-co-planar mating surfaces.

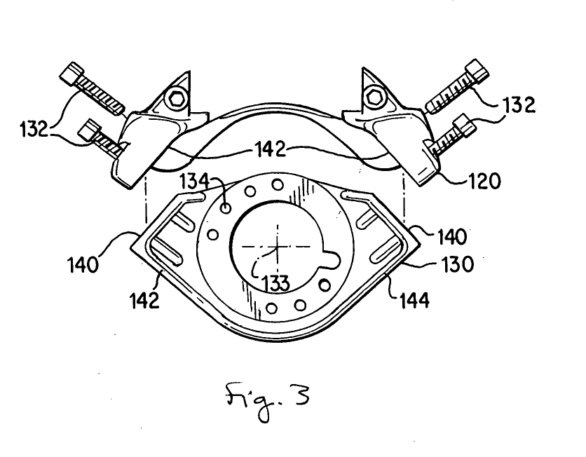

FIG. 4 is an exploded elevation view of the pneumatic disk brake mounting system with vertically-oriented mounting bolts and mating surfaces of FIG. 2 with location features in accordance with the present invention.

FIG. 5 is a cross-section view of a mounting bolt hole and shear sleeve shown in FIG. 4..

FIG. 6 is a schematic view of an alternative embodiment of a locator feature arrangement in a torque plate in accordance with the present invention.

### DETAILED DESCRIPTION OF THE DRAWINGS

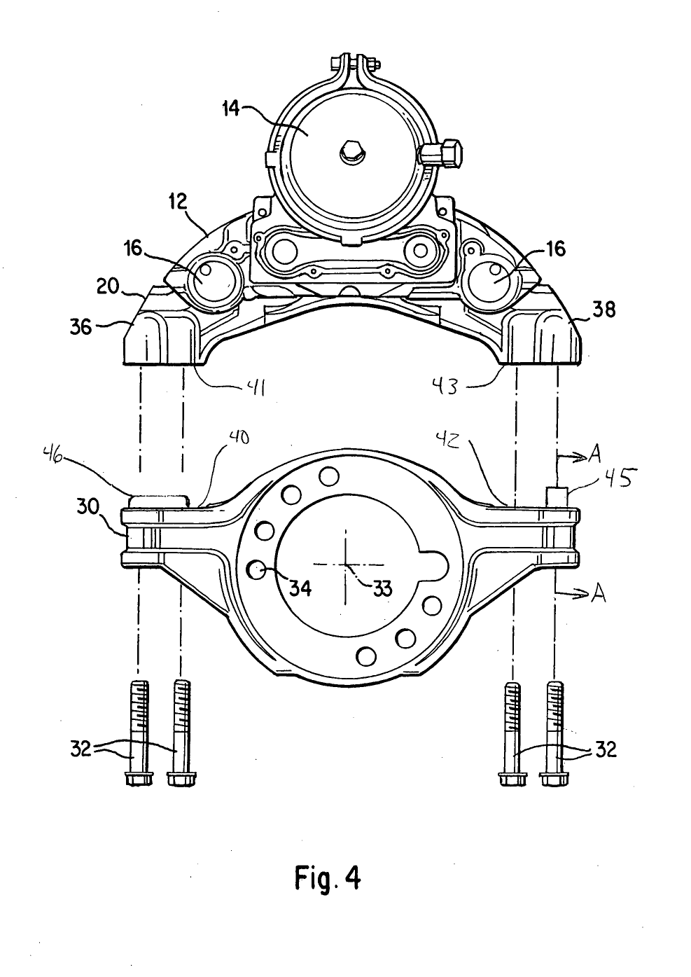

An embodiment of the present invention is illustrated in FIG. 4. In this embodiment, disk brake caliper 12, with pneumatic brake actuator 14 mounted thereon, is mounted via pins (located beneath seal covers 16) to a caliper mounting frame 20. Those of ordinary skill in the art will recognize that while the present invention is described herein as including a disk brake caliper with a pneumatic brake actuator, an electric brake actuator may be readily substituted for the pneumatic brake actuator.

The caliper mounting frame 20 is located in this embodiment on torque plate 30, and secured by frame mounting bolts 32 which pass through the torque plate and thread into corresponding threads in mounting frame bosses 36, 38. The mounting bolts 32 apply clamping forces to secure the mating surfaces 40, 42 of the torque plate 30 against the mating surfaces 41, 43 or the mounting frame. There are a plurality of mounting bolts 32 at each end of the mounting frame 20, the bolts being aligned in one or more planes approximately perpendicular to the longitudinal axis of the axle 33. The torque plate 30 is configured to be located concentrically about a hub end of a vehicle axle (not illustrated) having, and secured to an axle flange (not illustrated) by bolts passing through holes 34. As will be evident to those of ordinary skill in the art, the mounting bolts 32 securing the caliper mounting frame 20 to the torque plate 30 are located sufficiently far away from the longitudinal axis of the axle 33 that when disk brake caliper assembly 10 is located on an axle and the associated wheel has been removed, a technician will have essentially unfettered access to the mounting bolts 32 to permit their rapid removal and installation, preferably with pneumatic tools to minimize the effort and time required for the service operation.

FIG. 4 further illustrates two locator features on the mating surfaces 40, 42 of the torque plate, shear sleeve 45 and ridge 46. Corresponding recesses (not visible in this view) are provided to receive shear sleeve 45 and ridge 46 in the respective mating surfaces 41, 43 of mounting frame 20. The present invention is not limited to placement of locator features 45, 46 on the torque plate 30, as one or more locator features may alternatively be located on mounting frame 20, with their receiving recesses on the opposing mating surface. The invention is similarly not limited to the use of a shear sleeve as a locator feature which constrains two degrees of freedom; for example, a pin located in a bore in mating surface 42 between adjacent mounting bolt holes could provide the desired locating of a shear sleeve, without the need to provide a counter-bore about one of the mounting bolt holes. If the pin were located in line with one of the bolt holes shown in FIG. 4, it would appear similar to shear sleeve 45 in profile, and therefore this alternative is not further illustrated.

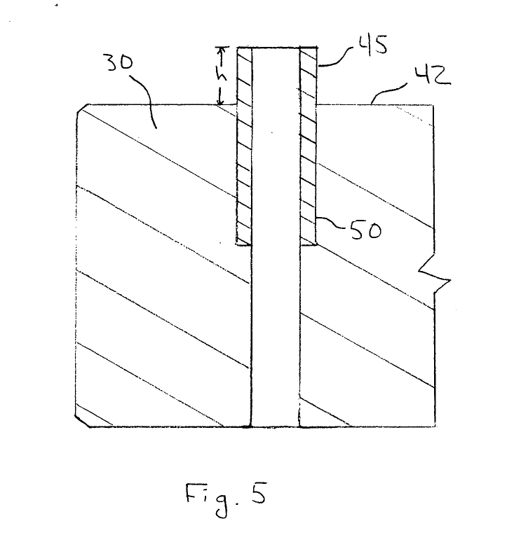

As shown in FIG. 5, a cross-section through section A-A in FIG. 4, shear sleeve 45 is located in a counter-bored hole 50 in torque plate 30. The sleeve inner diameter is at least as great as the outer diameter of the mounting bolts 32, so that the mounting bolt may pass through the torque plate and shear sleeve without interference from the sleeve. The corresponding receiving hole in mounting frame 20 (not illustrated) is counter-bored to a depth greater than the height h of the shear sleeve 45 above the mating surface 42 in order to ensure the sleeve does not prevent the mating surfaces 42, 43 from contacting one another. The inner diameter of the corresponding receiving hole in mounting frame 20 provides a close-tolerance fit to the outer diameter of the sleeve, in order to minimize motion in the four degrees of freedom parallel to mating surface 42.

The ridge 46 provided on torque plate mating surface 46 in this embodiment is integrally formed with the torque plate and machined to its final dimensions, as is its corresponding receiving slot in mating surface 41 of mounting frame 20. As with the counter-bore in mounting frame mating surface 43 which receives shear sleeve 45, the slot is machined to provide a close-tolerance fit to the ridge 46 to minimize component motion as the ridge resists rotation of the mounting frame relative to the torque plate.

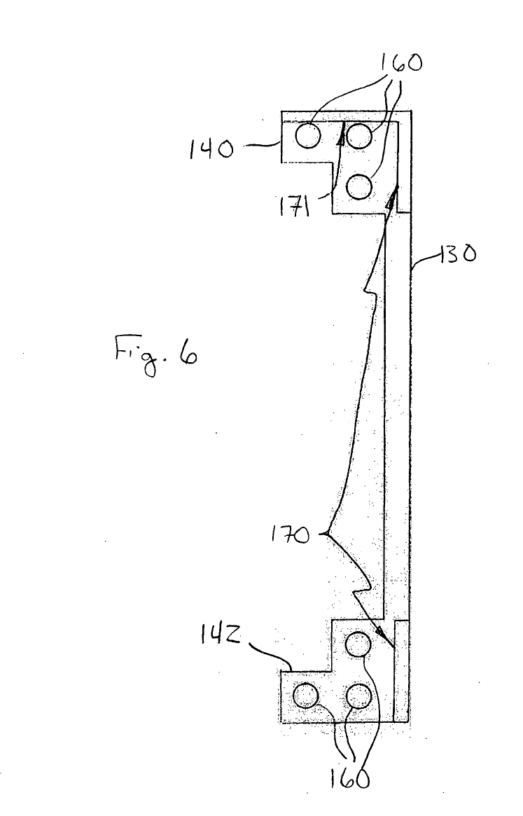

A further embodiment of the present invention is shown in FIG. 6. FIG. 6 is a schematic view looking down onto a top surface of a torque plate 130, showing mating surfaces 140, 142 and holes 160 through which mounting bolts (not illustrated) pass. In this embodiment, rather than providing a shear sleeve to limit motion in four degrees of freedom and a single ridge to control rotation, three locating ridges 170, 171 are provided on the mating surfaces 140, 142. One ridge 171 is located in this embodiment on an edge of mating surface 140, perpendicular to an adjacent ridge 170. The two adjacent ridges thereby constrain the four transverse degrees or freedom, while the remaining ridge 170 on mating surface 142 precludes “clocking” (rotation) of the mounting frame about the torque plate.

The foregoing disclosure has been set forth merely to illustrate the invention and is not intended to be limiting. For example, one of ordinary skill will recognize that wide variety of mechanical devices may be used to provide the desired constraints on the degrees of freedom of motion between the mounting frame and its mount onto the vehicle axle. Because other such modifications of the disclosed embodiments incorporating the spirit and substance of the invention may occur to persons skilled in the art, the invention should be construed to include everything within the scope of the appended claims and equivalents thereof.

What is claimed is:

1. A caliper assembly of a pneumatically- or electrically-actuated disk brake, comprising:
a pneumatically- or electrically-actuated brake caliper;
a caliper mounting frame; and
a torque plate;
wherein
the caliper is secured to the mounting frame,
the caliper mounting frame is secured to the torque plate by a plurality of fasteners,
the torque plate is configured to be secured to a vehicle axle,
at least one of the fasteners is oriented with its longitudinal axis in a plane essentially perpendicular to a longitudinal axis of the vehicle axle when the caliper assembly is in an in use position, and
at least one of the mounting frame and the torque plate includes at least one locator feature arranged to constrain relative motion between the mounting frame and the torque plate when the mounting frame is secured to the torque plate.

2. The caliper assembly of claim 1, wherein the at least one locator feature includes a first locator feature arranged to constrain two degrees of freedom of motion between the mounting frame and the torque plate.

3. The caliper assembly of claim 2, wherein the first locator feature arranged to constrain two degrees of freedom of motion between the mounting frame and the torque plate is one of a shear sleeve and a locating pin.

4. The caliper assembly of claim 2, wherein the at least one locator feature includes a second locator feature arranged to constrain a third degree of freedom of motion between the mounting frame and the torque plate.

5. The caliper assembly of claim 3, wherein the at least one locator feature includes a second locator feature arranged to constrain a third degree of freedom of motion between the mounting frame and the torque plate.

6. The caliper assembly of claim 4, wherein the second locator feature is one of a shear sleeve, a locating pin and a ridge.

7. The caliper assembly of claim 5, wherein the second locator feature is one of a shear sleeve, a locating pin and a ridge.

8. The caliper assembly of claim 1, wherein the at least one locator feature includes a first locator feature in the form of a ridge, a second locator feature in the form of a ridge arranged approximately perpendicular to the first locator feature relative to a plane containing a longitudinal axis of the axle, and a third locator feature in the form of a ridge arranged parallel to the first locator feature.

9. A mount for a caliper of a pneumatically- or electrically-actuated disk brake, comprising:
a mounting frame configured to support the caliper thereon,
wherein
when in an in use position, the mounting frame is secured to a vehicle axle by a plurality of fasteners to a mounting surface, and at least one of the fasteners is oriented with its longitudinal axis in a plane essentially perpendicular to a longitudinal axis of the vehicle axle, and
the mounting frame includes at least one of a locator feature and a locator recess arranged to receive a locator feature, said locator feature being arranged to constrain relative motion between the mounting frame and the mounting surface when the mounting frame is secured to the torque plate.

10. The caliper mount of claim 9, wherein the at least one locator feature and locator recess is arranged to cooperate with a corresponding locator recess or locator feature of the mounting surface to constrain two degrees of freedom of motion between the mounting frame and the mounting surface.

11. The caliper mount of claim 9, wherein the locator feature or locator recess of the mounting frame is arranged to constrain two degrees of freedom of motion between the mounting frame and the mounting surface is one of a shear sleeve and a locating pin if the mounting frame includes a locator feature, and one of a shear pin recess and a locating pin recess if the mounting frame includes a locator feature recess.

12. The caliper mount of claim 10, wherein the mounting frame includes one of a locator feature and a locator feature recess arranged to cooperate with a corresponding locator recess or locator feature of the mounting surface to constrain a third degree of freedom of motion between the mounting frame and the mounting surface.

13. The caliper mount of claim 11, wherein the mounting frame includes one of a locator feature and a locator feature recess arranged to cooperate with a corresponding locator recess or locator feature of the mounting surface to constrain a third degree of freedom of motion between the mounting frame and the mounting surface.

14. The caliper mount of claim 12, wherein the locator feature or the locator recess is one of a shear sleeve, a locating pin and a ridge if the mounting frame includes a locator feature, and one of a shear pin recess, a locating pin recess and a ridge recess if the mounting frame includes a locator feature recess.

15. The caliper mount of claim 13, wherein the locator feature or the locator recess is one of a shear sleeve, a locating pin and a ridge if the mounting frame includes a locator feature, and one of a shear pin recess, a locating pin recess and a ridge recess if the mounting frame includes a locator feature recess.

16. The caliper mount of claim 9, wherein the mounting surface is a mating surface of a torque plate affixed to the axle.

17. The caliper mount of claim 9,
wherein
the at least one of a locator feature and a locator recess arranged to receive a locator feature includes a total of three of said locator features and/or said locator recesses,
two of the total of three locator features and/or said locator recesses are arranged parallel to one another on the mounting frame, and
the remaining one of the total of three locator features and/or locator recesses is arranged approximately perpendicular to the two parallel locator features and/or locator recesses.

18. The caliper assembly of claim 17, wherein said total of three locator features and said locator recesses includes at least one of a ridge and a recess arranged to receive a ridge.

19. A pneumatically- or electrically-actuated disk brake, comprising:
a brake disk;
a pneumatically- or electrically-actuated brake caliper which straddles the brake disk when in an in use position;
a caliper mounting frame; and
a torque plate;
wherein
the caliper is secured to the mounting frame,
the caliper mounting frame is secured to the torque plate by a plurality of fasteners,
the torque plate is configured to be secured to a vehicle axle,
at least one of the fasteners is oriented with its longitudinal axis in a plane essentially perpendicular to a longitudinal axis of the vehicle axle when the caliper is in the in use position, and
the mounting frame includes at least one of a locator feature and a locator recess arranged to receive a locator feature, said locator feature being arranged to constrain relative motion between the mounting frame and the mounting surface when the mounting frame is secured to the torque plate.

20. A mounting device for mounting a pneumatically- or electrically-actuated disk brake caliper to a vehicle axle, comprising:
a torque plate configured to support at least one of a caliper and a caliper mounting frame thereon,
wherein
when in an in use position, the torque plate is arranged to receive the caliper or the caliper mounting frame and to receive a plurality of fasteners for securing said caliper or caliper mounting frame to a mounting surface of the torque plate, wherein at least one of the fasteners is received with its longitudinal axis in a plane essentially perpendicular to a longitudinal axis of the vehicle axle, and
the torque plate includes at least one of a locator feature and a locator recess arranged to receive a locator feature, said locator feature being arranged to constrain relative motion between the torque plate mounting surface and the caliper or the caliper mounting frame when secured to the torque plate.
